(19) United States
(12) Patent Application Publication
(10) Pub. No.: US 2020/0236758 A1
(43) Pub. Date: Jul. 23, 2020

(54) AUTOMATED STREETLIGHT SYSTEMS AND METHODS

(71) Applicants: Nikhil Lokhande, Ridgeland, MS (US); Kyle Patrick McCrary, Starksville, MS (US)

(72) Inventors: Nikhil Lokhande, Ridgeland, MS (US); Kyle Patrick McCrary, Starksville, MS (US)

(21) Appl. No.: 16/749,850

(22) Filed: Jan. 22, 2020

Related U.S. Application Data
(60) Provisional application No. 62/795,054, filed on Jan. 22, 2019.

(51) Int. Cl. H05B 45/12; H05B 47/11; H05B 47/155; H05B 47/165; F21S 8/08

(52) U.S. Cl. CPC H05B 45/12; H05B 47/11; F21W 2131/103; H05B 47/165; F21S 8/086; H05B 47/155

(57) ABSTRACT

An automated streetlight system of the present disclosure has a master streetlight, that has a network interface, at least one master streetlight light emitting diode (LED), and a plurality of sensors for collecting environmental information. Additionally, the automated streetlight system comprises a slave streetlight, the slave streetlight comprising at least one slave streetlight LED and a master streetlight processor that determines an LED color and an LED intensity based on the collected information, the master streetlight processor further configured to activate the at least one master streetlight LED with the determined LED color and the determined LED intensity and active the at least one slave streetlight LED with the determined LED color and the determined LED intensity.

### CROSS-REFERENCE TO RELATED APPLICATION

This application claims priority to U.S. Provisional Application Ser. No. 62/795,054 entitled Automated Weather visibility and Monitoring Lighting System and filed Jan. 22, 2019, which is incorporated here by reference.

### BACKGROUND

Thousands of deaths are caused each year by a lack of nighttime visibility on roadways during inclement weather conditions, such as rainstorms, snow, and fog. Improvements in lighting technology over the years has led the way to the current standard of high-pressure sodium lights. Also, newer LED streetlights are on the market today.

Bad lighting on roadways is a preventable road condition that ultimately leads to more deaths and injuries. Many streetlights today are simple halogen, sodium-vapor, or LED lights that can only detect ambient lighting from their environments. While smart street lighting is becoming more prevalent, most designs fall short of addressing all the important issues required for safe roadway lighting.

However, there has been little headway made in streetlight smart connectivity. Existing streetlights do very little in the way of actively contributing in public safety other than providing standardized lighting. Even though safety is one of the primary goals for streetlights around the world, never has a streetlight been an integrated part of an emergency preparedness.

### BRIEF DESCRIPTION OF THE FIGURES

FIG. 1 is block diagram of an exemplary automated streetlight system in accordance with an embodiment of the present disclosure.

FIG. 2 is a block diagram of an exemplary streetlight control server as depicted in FIG. 1.

FIG. 3 is a block diagram of an exemplary user interface device as depicted in FIG. 1

FIG. 4 is a block diagram of an exemplary master streetlight as depicted in FIG. 1

FIG. 5 is a block diagram of an exemplary slave streetlight as depicted in FIG. 1.

FIG. 6 is a flowchart depicting the architecture and functionality of the master streetlight depicted in FIG. 1.

FIG. 7 is a flowchart depicting the architecture and functionality of the slave streetlight.

### DETAILED DESCRIPTION

The present disclosure describes an exemplary automated streetlight system. The exemplary automated streetlight system of the present disclosure comprises a master streetlight, one or more slave streetlights, a network and a streetlight controller server

The master streetlight comprises a plurality of sensors for detecting data indicative of characteristics of its environment. For example, the master light may detect rain, snow, sleet, pressure, humidity, light, etc. Other characteristics may be detected in other embodiments. The master streetlight has a housing, and contained in this housing is a barometer, a humidity sensor, and a temperature sensor. Some sensors may necessarily be exposed to the element, such as the rain module or the photo detector, due to their functionality. That is, a rain module is outside of the housing so that it may collect rain and the photodetector is outside of the housing in order to capture images of the environment.

The master streetlight comprises one or more RGB light emitting diodes (LEDs). The master streetlight is configured to control the color and intensity of the LEDs based upon the weather characteristic data. In this regard, the master streetlight can choose the most optimal lighting color and intensity by manipulating it RGB LEDs.

In one embodiment, the automated streetlight system comprises a camera. The camera is configured to periodically or upon demand capture images of its environment. That is, the physical environment surrounding the master streetlight, which is described further herein.

The master streetlight further comprises a radio transceiver and a network transceiver, which are described further herein. The network transceiver communicatively couples the master light to the streetlight control server or a third-party server over a network, such as the Internet. The radio transceiver communicatively couples the master light to one or more slave lights, which is described below.

The automated streetlight system further comprises the one or more slave streetlights. Each slave streetlight comprises one or more LEDs. The slave streetlights do not necessarily have to have the variety of sensors like the master streetlight because the slave streetlights receive commands from the master streetlight regarding changes to lighting. In response, the slave streetlight modifies the lighting of the LEDs based on the commands received. Each slave streetlight listens for these commands from the master streetlight defining the color and intensity of the LEDs on the slave streetlights. In response, the slave streetlight controls its LEDs based upon commands received from the master streetlight.

In this regard, each slave streetlight comprises at least a radio transceiver. The slave streetlights are communicatively coupled to the master streetlight via a radio communications scheme. That is, the radio transceiver of the master streetlight communicatively couples to each of the radio transceivers of the one or more slave streetlights.

In operation, the master streetlight is configured to transmit LED commands to each of the one or more slave streetlights. The command provided by the master streetlight comprises data for controlling the color and intensity of the LEDs on the slave streetlights. The data indicative of the command can be determined by the mast streetlight or it may be determined by the streetlight controller server.

In one embodiment, the master streetlight determines the data indicative of the command. In this regard, the master streetlight receives data from the various sensors. For example, the sensors may be a rain module, barometer, a humidity sensor or a temperature sensor. The master streetlight may determine the best light for the weather conditions and control the master streetlights and the slave lights based upon these weather conditions. Upon determination of the best light for the weather conditions, the master streetlight may transmit data indicative of the LED colors, e.g., red, blue, and green, to the slave street lights.

Further, the streetlight controller server communicates bi-directionally with the master streetlight. In this regard, the master streetlight may transmit data indicative of the weather, including pressure, humidity, temperature, rain, and images. The streetlight controller server may determine what light would be best given the conditions provided by the master streetlight. In one embodiment, the streetlight controller server may use artificial intelligence (AI) to determine the best lighting for the environmental factors. Notably, the streetlight controller server may receive an image from the master streetlight, e.g., when fog is present, and determine that fog is present. The streetlight controller server would then transmit data indicative of lighting suitable for a foggy environment to the master streetlight, and the master streetlight can transmit the data indicative of the colors most suitable for fog to the slate streetlights as well as controlling the master streetlight LEDs based upon the data received from the streetlight controller server.

The automated streetlight system may also comprise a third-party server. The third party comprises a third-party processor. The processor is configured to provide information such as a nearby medical emergency, a nearby fire emergency, construction, or weather warnings, e.g., tornados. The third-party server is communicatively coupled to the master streetlight via the Internet. Upon receipt from a third-party server regarding a special situation, the master streetlight may change the color of its LEDs to orange, for example, and send a command to the slave streetlights to change the colors of their LEDs to orange, for example, to indicate the special situation. Thus, the automated streetlight system will be able to relay important data to drivers such as weather threats or other emergencies through a color-coding system that utilizes specific colors, fading styles, and intensities.

The automated streetlight system may also comprise a mobile device. The mobile device is communicatively coupled to the master streetlight via the Internet. The mobile device may be used by a utility company, for example, to install the automated streetlight system. Further, the mobile device may be used by someone to change the lighting of the master streetlight and the slave streetlights.

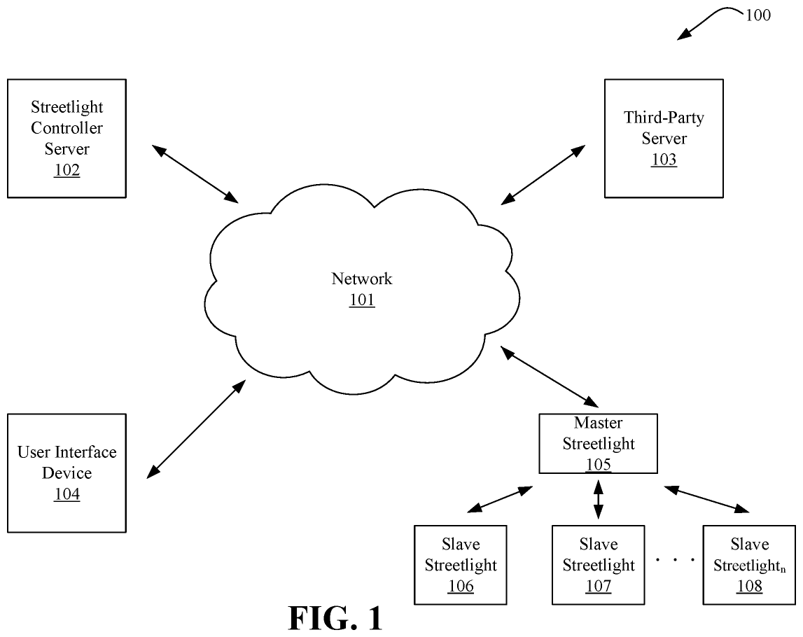

FIG. 1 is a block diagram of an exemplary automated streetlight system 100 in accordance with an embodiment of the present disclosure. The automated streetlight system 100 comprises a master streetlight 105 communicatively coupled to a plurality of slave streetlight 106-slave streetlightₙ 108. In one embodiment, the master streetlight 105 communicates with each of the slave streetlights 106-slave streetlightₙ 108 via radio; however, other communications means may be used in other embodiments.

Further, the automated streetlight system 100 comprises a streetlight controller server 102. The streetlight controller server 102 is communicatively coupled to the master streetlight 103 via a network 101. The network 101 may be, for example, the Internet. In such a scenario, the master streetlight 105 may communicate using Web services created with representational state transfer (REST), which is a software architecture that defines a set of constraints to be used. RESTful Web services provide interoperability between the master streetlight 105 and the streetlight controller server 102. Note that using RESTful Web services is merely an example. Other types of communication means may be used for the interoperability between the master streetlight 105 and the streetlight controller server 102 in other embodiments.

The automated streetlight system 100 further comprises a third-party server 103. The third-party server 103 is any server that is capable of sending data over the network 100 to the master streetlight 105 indicative of flood warnings, hurricane warnings, police presence, construction work, etc.

The automated streetlight system 100 further comprises a user interface device 104. The user interface device 104 may be, for example, a mobile phone, a table, or a computer. The user interface device 104 may be used by a user to install the automated streetlight system 100. In addition, the user interface device 104 has the capability to allow the user to control data send to the master streetlight 105, thereby providing the ability to control the LEDs.

In operation, the master streetlight 105 collects information about its environment, including information about rain, humidity, pressure, temperature, and photographs. Given some of this information, the master streetlight 105 can determine what color and intensity is best for the given environment. Once a determination is made, the master streetlight 105 changes its LEDs to the determined color and intensity. Further, via its radio transceiver (not shown), the master streetlight 105 transmits a command to each of its slave streetlights comprising data indicative of the color and intensity determined.

The slave streetlight 106-slave streetlightₙ 108 receives the data from the master streetlight 105. Upon receipt, the streetlight 106-slave streetlightₙ 108 change the color and intensity of their respective LEDs according to the data receive from the master streetlight 105.

There are times when the master streetlight 105 may not be able to reach a sure decision about how the colors and intensities should be manipulated according to the environment. In such scenario, the master streetlight 105 transmits data indicative of each of the sensors and an image of the environment to the streetlight controller server 102.

Upon receipt, the streetlight controller server 102 determines what color and what intensity the LEDs should exhibit given the weather conditions. The streetlight controller server 102 transmits data to the master streetlight 105 indicative of the color and intensity of the master streetlight 105. In response, the master streetlight 105 changes its LED color and intensity to match what was provided by the streetlight controller server 102.

Further, the master streetlight 105 transmits data indicative of the color and the intensity to the slave streetlight 106-streetlightₙ 108. Upon receipt, the slave streetlight 106-slave streetlightₙ 108 change their LED color and intensity based upon the data received from the master streetlight 105.

Also, during operation, there may be an emergency, such as a flood, a hurricane, police presence, or construction work ahead. In such scenario, the master streetlight 105 can list for alerts of these types from third-party server 103. If the master streetlight 105 detects data indicative of an emergency of this type, the master streetlight 105 may change the color and intensity of its LEDs to a particular color, e.g., orange. Further, the master streetlight 105 may send commands to the slave streetlight 106-slave streetlightₙ 108 to change the color and intensity of their LEDs as well.

Note that when a user can access the automated streetlight system 100 through the user interface device 104. For example, utility personnel may use a user interface device 104, e.g., a mobile phone, a tablet, or a computer to install the master streetlight 105 and slave streetlight 106-slave streetlightₙ 180. The user interface device allows the user to install new lights, search for lights, view all lights, or change out a light. The user interface device 104 may also allow a user to search for and view all master streetlights 105 and slave streetlights 106-slave streetlightₙ 108. In either application, the user or utility personnel login to the automated streetlight system 100. Before the user or utility personnel can have access to the system, they are authenticated by the streetlight controller server 102. In this regard, the user or utility personnel may have to use a username and password to gain access to the automated streetlight system 100.

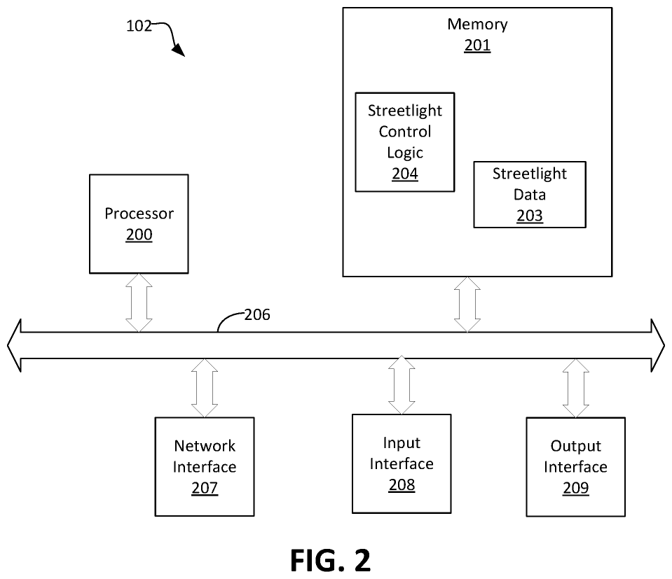

FIG. 2 is a block diagram of the streetlight controller server 102. As shown by FIG. 2, the streetlight controller server 102 comprises a processor 200, a network interface 207, and memory 201. Stored in memory 201 are streetlight control logic 204 and streetlight data 203.

The streetlight control logic 204 generally controls the functionality of the streetlight controller server 102, as will be described in more detail hereafter. It should be noted that the streetlight controller logic 204 can be implemented in software, hardware, firmware or any combination thereof. In an exemplary embodiment illustrated in FIG. 2, the streetlight controller logic 204 is implemented in software and stored in memory 201.

Note that the streetlight controller logic 204, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary embodiment of the streetlight controller server 102 depicted by FIG. 2 comprises at least one conventional processing element 200, such as a digital signal processor (DSP) or a central processing unit (CPU), that communicates to and drives the other elements within the streetlight controller logic 204 via a local interface 206, which can include at least one bus. Further, the processing element 200 is configured to execute instructions of software, such as the streetlight controller logic 204.

The streetlight controller logic 204 may also comprise artificial intelligence (AI) logic. In such a scenario, the AI logic may perform tasks, such as visual perception of an environment given an image taken in the environment. Further, the AI logic may perform automated decision-making determining what color and intensity an LED needs to be during given environmental conditions. These a merely a couple of tasks that the AI logic may perform. There may be other tasks in other embodiments.

The streetlight data 203 is any data that the streetlight control logic 204 may use to determine a color or intensity for an LED based upon weather conditions. In this regard, the streetlight data 203 may comprise data indicative of a plurality of environmental conditions associated with a particular LED color and LED intensity. That is, if there is rain present, there is a set of RED-BLUE-GREEN (RGB) values identified for rain and there is a particular intensity identified for rain.

An input interface 208, for example, a keyboard, keypad, or mouse, can be used to input data from a user of the external streetlight controller server 102. Further, an output interface 209, for example, a printer or display screen (e.g., a liquid crystal display (LCD)), can be used to output data to the user.

In addition, a network interface 207, such as a modem, enables the streetlight controller server 102 to communicate via the network 101 (FIG. 1) with the master streetlight 105 (FIG. 1), the user interface device 104 (FIG. 1), and the third-party server 103 (FIG. 1).

In operation, the streetlight controller server 102 listens for information from the master streetlight 105 or the user interface device 104. If the streetlight controller server 102 receives a request from the master streetlight 105, the streetlight control logic 204 uses the data describing the environment and provided by the master streetlight 105 to make a determination of an LED color and LED intensity that would be best suited given the environmental factors provided by the master streetlight 105. This determination is made based upon streetlight data 203 indicative of weather. The streetlight control logic 204 determines the LED color and LED intensity based upon the RGB data and other intensity data for the weather at hand, which is stored in the streetlight data 203. If there is an image in the data provided by the master streetlight 105, the streetlight control logic 204 may compare the image to images stored in the streetlight data 203 to determine the type of environment is being exhibited. The streetlight control logic 204 could then use the results of the comparison to determine the LED color o the LED intensity for the given environment.

In one embodiment, the images provided by the master streetlight 105 may be stored as streetlight data 203. The images represent photographs taken in the field-of-view of the master streetlight 105. Thereafter, when the streetlight controller server 102 receives an image, the streetlight control logic 204 may compare the received image to the images stored n the streetlight data 203 in order to determine what weather is represented by the received image. In another embodiment, the streetlight control logic 204 is configured to detect an image type by using untrained machine learning models, which look for patterns within the image.

Once the streetlight control logic 204 has decided as to the LED color and LED intensity, the streetlight control logic 204 transmits data indicative of the LED color and LED intensity to the master streetlight 105. The master streetlight 105 changes its LED color and LED intensity to match that provided by the streetlight control logic 204. The master streetlight 105 transmits data indicative of the LED color and the LED intensity to the slave streetlight 106-slave streetlightₙ 108.

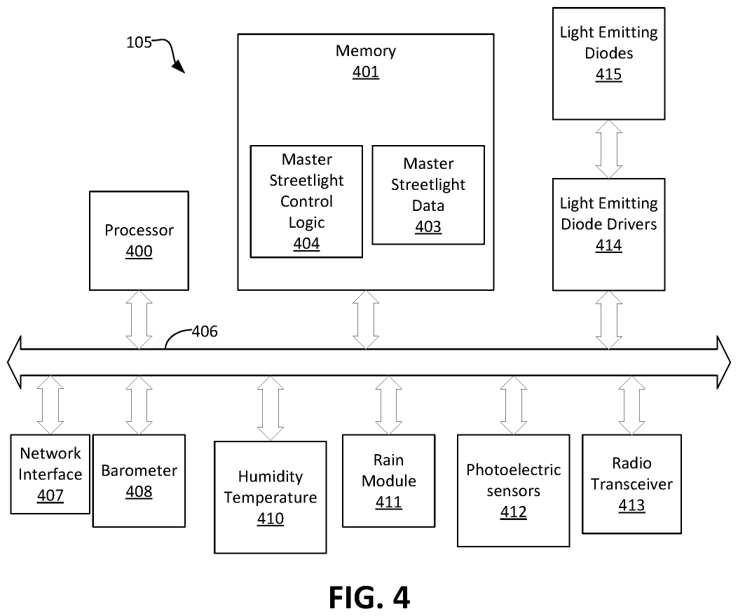

In one embodiment, the master streetlight 105 (FIG. 4) may transmit data indicative of sensor readings to the streetlight controller server 102. In such a scenario, the streetlight control logic 204 stores the data received in the streetlight data 203. The streetlight control logic 204 may perform analysis and data mining on the streetlight data 203 that involves machine learning (AI), statistics and the streetlight data 203. In this regard, the streetlight control logic 204 may process the streetlight data 203 to find anomalies, patters, and correlations within the streetlight data 203. The information obtained from the data analysis and data mining may enable the streetlight control logic 204 to predict outcomes related to the master streetlight 105.

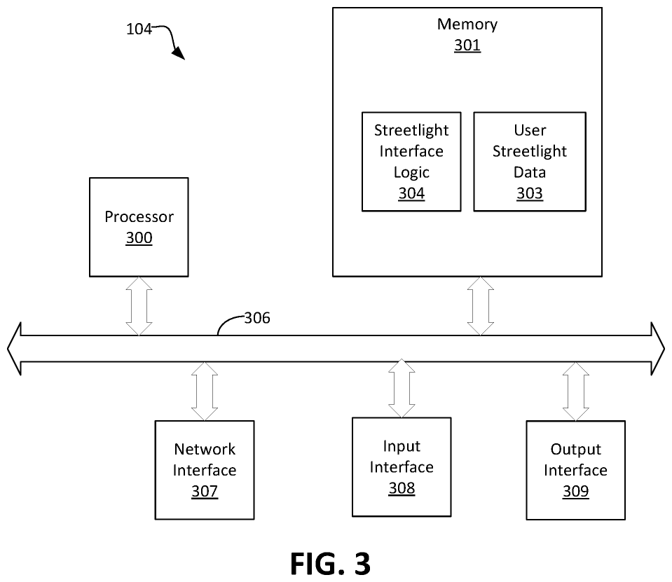

FIG. 3 is a block diagram of the user interface device 104. As shown by FIG. 3, the user interface device comprises a processor 300, a network interface 307, and memory 301. Stored in memory 301 are streetlight interface logic 304 and user streetlight data 303.

The streetlight interface logic 304 generally controls the functionality of the user interface device 104, as will be described in more detail hereafter. It should be noted that the streetlight interface logic 304 can be implemented in software, hardware, firmware or any combination thereof. In an exemplary embodiment illustrated in FIG. 3, the streetlight interface logic 304 is implemented in software and stored in memory 301.

Note that the streetlight interface logic 304, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary embodiment of the user interface device 104 depicted by FIG. 3 comprises at least one conventional processing element 300, such as a digital signal processor (DSP) or a central processing unit (CPU), that communicates to and drives the other elements within the streetlight interface logic 304 via a local interface 306, which can include at least one bus. Further, the processing element 300 is configured to execute instructions of software, such as the streetlight interface logic 304.

The user streetlight data 303 is any data that the streetlight interface logic 304 may use to determine install or manage a master streetlight 105 and its slave streetlight 106-slave streetlightₙ 108.

An input interface 308, for example, a keyboard, keypad, or mouse, can be used to input data from a user of the external streetlight controller server 102. Further, an output interface 309, for example, a printer or display screen (e.g., a liquid crystal display (LCD)), can be used to output data to the user.

In addition, a network interface 307, such as a modem, enables the user interface device 104 to communicate via the network 101 (FIG. 1) with the master streetlight 105 (FIG. 1), the streetlight controller server (FIG. 1), and the third-party server 103 (FIG. 1).

In operation, the user interface device 104 may be used to interface with the master streetlight 105, the streetlight controller server 102 and the third-party server 103. In one embodiment, the user interface device 104 can be used to install a new streetlight. In another embodiment, a user interface device 104 may be used to search for a streetlight and change its configuration. Also, a user using the user interface device 104 can replace and change out a streetlight.

FIG. 4 is a block diagram of the master streetlight 105. As shown by FIG. 4, the master streetlight 105 comprises a processor 400, a network interface 407, and memory 401. Stored in memory 401 are master control logic 404 and master streetlight data 403. Additionally, the master streetlight 105 comprises one or more LED drivers 414 that provide instruction to the one or more LEDs 415.

The streetlight interface logic 304 generally controls the functionality of the user interface device 104, as will be described in more detail hereafter. It should be noted that the streetlight interface logic 304 can be implemented in software, hardware, firmware or any combination thereof. In an exemplary embodiment illustrated in FIG. 3, the streetlight interface logic 304 is implemented in software and stored in memory 301.

Note that the master control logic 404, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary embodiment of the master streetlight 105 depicted by FIG. 4 comprises at least one conventional processing element 400, such as a digital signal processor (DSP) or a central processing unit (CPU), that communicates to and drives the other elements within the master streetlight 105 via a local interface 406, which can include at least one bus. Further, the processing element 400 is configured to execute instructions of software, such as the master control logic 404.

The master streetlight data 403 is any data that the master streetlight logic 404 may use to determine manage a master streetlight 105 and its slave streetlight 106-slave streetlightₙ 108.

Additionally, the master streetlight 105 comprises numerous sensors. The master streetlight 105 comprises a barometer, which measures pressure, and the barometer alerts the master streetlight 105 of impending extreme weather conditions. The master streetlight 105 comprises a humidity/temperature interface 410, which measures both the temperature and humidity, and a rain module that measures the amount of rain that has fallen. The master streetlight 105 further comprises a photoelectric sensor. In one embodiment, the automated streetlight control system 100 comprises more than one photoelectric sensor 412. In one embodiment, there is a photoelectric sensor on the top of the master streetlight 105 for measuring ambient daytime lighting and another photoelectric sensor is on the underside of the master streetlight 105 for measuring the relevant lighting output.

Additionally, the master streetlight 105 comprises a radio transceiver 413. The radio transceiver 413 allows the master streetlight 105 to communicate with each of the slave streetlight 106-slave streetlightₙ 108. Thus, the master streetlight 105 can transmit data indicative of an LED color and an LED intensity to the slave streetlight 106-slave streetlightₙ 108.

In operation, the master streetlight 105 obtains values from its various sensors. For example, the master control logic 404 obtains a value from the barometer 408, the humidity/temperature sensor 410, the rain module 411, and the photoelectric sensors 412. The master control logic 404 compares the readings from the various sensors to data stored in the master streetlight data 403. That is, in the master streetlight data 403 there is LED color data and LED intensity data correlated with particular weather conditions. If the readings from the various sensors match a scenario stored in the master streetlight data 403, the master streetlight 105 transmits data indicative of the LED color and the LED intensity to the LED drivers 414, and the LED drivers change its LED color and LED intensity correlated with the sensor scenario. Further, the master control logic 404 transmits commands to its slave streetlight 106-slave streetlightₙ 108 to modify their LED color and LED intensity to suit the weather conditions.

If the master streetlight 105 is unable to determine an LED color and LED intensity for the LEDs on the master streetlight 105 and the slave streetlight 106-slave streetlightₙ 108, the master streetlight 105 transmits a query to the streetlight controller server 102 with the sensor data collected, including an image of the environment. The streetlight controller server 102 determines what the LED color and the LED intensity should be for the given environmental conditions. After determining what the LED color and LED intensity should be for the given sensor readings and the image, the streetlight controller server 102 transmits data indicative of an LED color and an LED intensity to the master streetlight 105. The master streetlight 105 sets its LEDs to the LED color and LED intensity provided by the streetlight controller server 102. The master streetlight 105 also transmits data indicative of the LED color and the LED intensity to the slave streetlight 106-slave streetlightₙ 108. The slave streetlight 106-slave streetlightₙ 108 set their LEDs to the provided LED color and LED intensity.

Also, in operation, the master streetlight 105 may receive data indicative of an emergency situation within proximity to the master streetlight 105 and the slave streetlight 106-slave streetlightₙ 108 from the third-party server 103. For example, there may be flooding, a tornado, construction on the rod, or a police presence. Upon receiving data indicative of an emergency, the master streetlight 105 changes it LED color and LED intensity based upon the type of emergency is indicated. For example, a tornado dictates that the LEDs are yellow, or a police presence dictates that the LEDs are blue. The color associated with a particular emergency is stored in the master streetlight data 403.

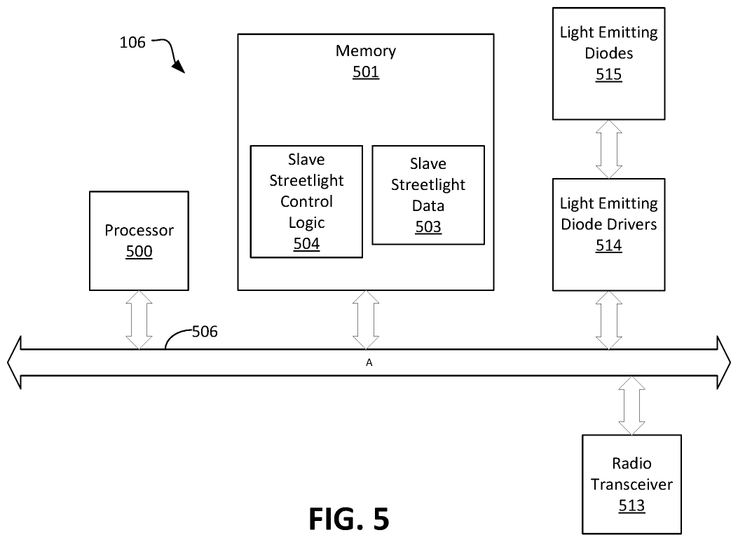

FIG. 5 is a block diagram of the slave streetlight 106. Note that only one block diagram for one slave streetlight 106 is shown. The other slave streetlights 107-108n behave identically to slave streetlight 106. As shown by FIG. 5, the slave streetlight 106 comprises a processor 500, a radio transceiver 513, and memory 501. Stored in memory 501 are slave control logic 504 and slave streetlight data 503. Additionally, the slave streetlight 106 comprises one or more LED drivers 514 that provide instruction to the one or more LEDs 515.

The slave control logic 504 generally controls the functionality of the slave streetlight 106, as will be described in more detail hereafter. It should be noted that the slave control logic 304 can be implemented in software, hardware, firmware or any combination thereof. In an exemplary embodiment illustrated in FIG. 5, the slave control logic 504 is implemented in software and stored in memory 501.

Note that the slave control logic 504, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary embodiment of the slave streetlight 106 depicted by FIG. 5 comprises at least one conventional processing element 500, such as a digital signal processor (DSP) or a central processing unit (CPU), that communicates to and drives the other elements within the slave streetlight 106 via a local interface 506, which can include at least one bus. Further, the processing element 500 is configured to execute instructions of software, such as the slave control logic 504.

The slave streetlight data 503 is any data that the slave streetlight control logic 504 may use to operate. For example, the slave streetlight data 503 may comprise data indicative of the most recent LED color and LED intensity received from the master streetlight 105.

Additionally, the slave streetlight 106 comprises a radio transceiver 513. The radio transceiver 513 allows the slave streetlight 106 to communicate with the master streetlight 105. Thus, the master streetlight 105 can transmit data indicative of an LED color and an LED intensity to the slave streetlight 106.

In operation, the slave streetlight control logic 504 listens for commands from the master streetlight 105. If the slave streetlight control logic 504 receives data indicative of an LED color and an LED intensity, the slave streetlight control logic 504 transmits data indicative of the LED color and the LED intensity to the LED drivers 514. The LED drivers 514 implement the change in the LEDs 515.

In one embodiment, each slave streetlight 106-slave streetlightₙ 108 comprises a radio transceiver (513 in FIG. 5). In normal operation, the slave radio transceiver communications over radio with the master streetlight 105. If the master streetlight 105 is not operational, and the slave streetlight 106-slave streetlightₙ 108 can no longer communicate with the master streetlight 105, the slave streetlights 106-slave streetlightn 108 operate autonomously. In this regard, the slave streetlight 106-slave streetlight 108, exhibit a neutral or white color or any other pre-selected LED color and LED intensity.

In one embodiment, the slave streetlight control logic 504 may transmit a LED default color and LED default intensity to the LED drivers 514, which in turn controls the LED color and LED intensity of the LEDs 515. In one embodiment, the slave streetlight 106-slave streetlightₙ 108 can communicated with each other over radio via their radio transceivers (not shown). This allows limited data sharing from one slave streetlight 106-slave streetlightₙ 108 to another while the master streetlight 105 is not operational.

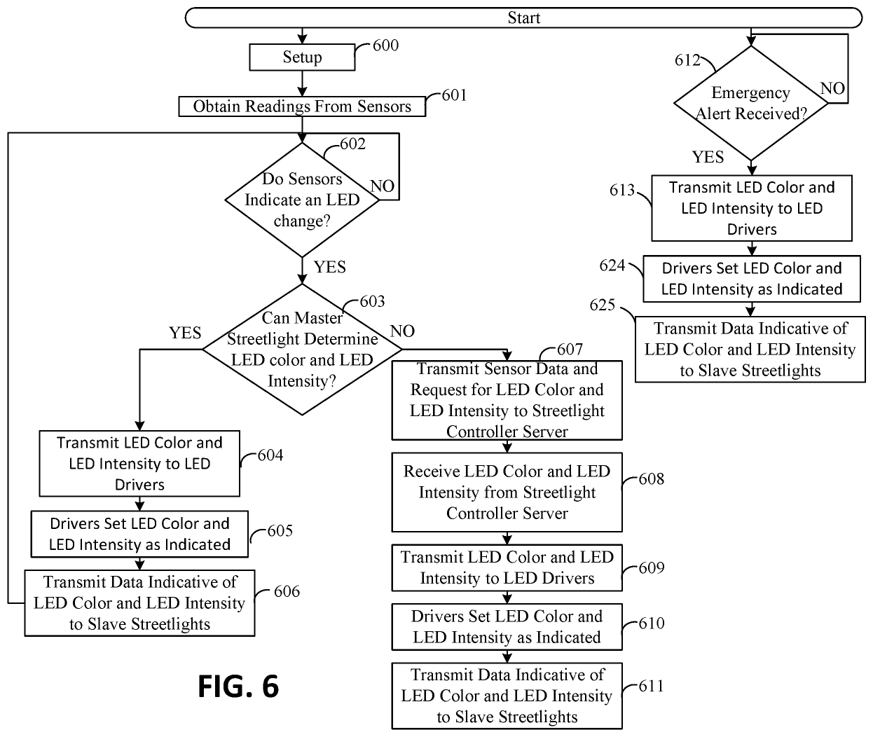

FIG. 6 is a flowchart depicting the architecture and functionality of the automated streetlight system 100 (FIG. 1). When the master streetlight 105 (FIG. 1) is powered on, the master streetlight control logic 404 (FIG. 4) performs a setup at step 600. At step 601, the master streetlight control logic 404 queries the various sensors for readings.

If the sensors indicated that an LED change is needed in step 602 and the master streetlight control logic 404 cannot determine the necessary LED color and LED intensity in step 603, the master streetlight control logic 404 transmits the collected sensor data to the streetlight controller server 102 in step 607.

In step 608, the master streetlight control logic 404 receives an LED color and an LED intensity from the streetlight controller server 102. The master streetlight control logic 404 transmits the LED color and LED intensity to the LED drivers 414 (FIG. 4) in step 609, and the LED drivers 414 set the LED color and the LED intensity as indicated. In step 611, the master streetlight control logic 404 transmits data indicative of the LED color and the LED intensity to the slave streetlight 106-slave streetlightₙ 108.

If the master streetlight control logic 404 can determine the necessary LED color and LED intensity in step 603, the master streetlight control logic 404 transmits the LED color and the LED intensity to the LED drivers 414 in step 604. In step 605, the LED drivers set the LED color and the LED intensity as indicated. In step 606, the master streetlight control logic 404 transmits data indicative of the LED color and LED intensity to slave streetlights 106-slave streetlightₙ 108.

In addition, the master streetlight control logic 404 (FIG. 1) listens for messages from the third-party server 103 (FIG. 1). If an emergency alert is received from the third-party server 103 in step 612, the master streetlight control logic 404 transmits an LED color and an LED intensity for the particular emergency to the LED drivers 414 (FIG. 4) on the master streetlight 105 in step 613. The LED drivers 414 set the LEDs 415 (FIG. 4) to the indicated LED color and the LED intensity for that particular emergency as indicated in step 624. Note that the automated streetlight system 100 may use different LED colors and different LED intensities depending upon the type of emergency and the type of weather.

Additionally, the master streetlight control logic 404 transmits data indicative of the LED color and the LED intensity to the slave streetlight 106 (FIG. 1)-Streetlightₙ 108 (FIG. 1) in step 625. As will be described further herein, upon receive of the data indicative of the LED color and the LED intensity, the slave streetlight control logic 504 (FIG. 5) transmits data indicative of the LED color and the LED intensity to the LED drivers 514, and the LED drivers 514 changed the LED color and LED intensity of the streetlight 106-Streetlightₙ 108.

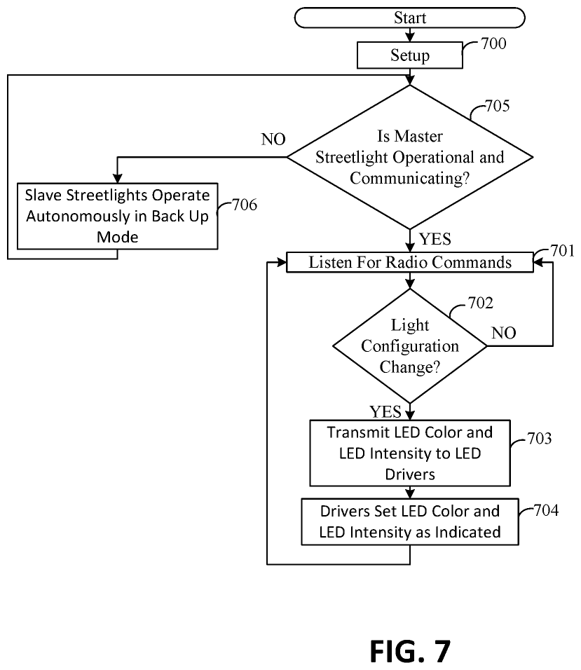

FIG. 7 is a flowchart depicting the architecture and functionality of the slave streetlights 106-slave streetlightₙ 108. When a slave streetlight 106-slave streetlightₙ 108 is powered on, the slave streetlight 106-slave streetlightₙ 108 perform a setup procedure in step 700.

If the master streetlight 105 is operation and communicating with the slave streetlight 106-slave streetlightₙ 108 in step 705, the slave streetlight 105-slave streetlightₙ 108 listen for radio commands from the master streetlight 105 in step 701. Note that a command shall have at least data indicative of LED color, e.g., RGB data. In another embodiment, the command also comprises data indicative of intensity.

If a command that is received is by the slave streetlight 106-slave streetlightₙ 108 is a light configuration change that comprises data effectuating a change in LED color or LED intensity in step 702, the slave streetlight control logic 504 (FIG. 5) transmits data indicative of the LED color and the LED intensity to the LED drivers 514 in step 703. In step 704, the drivers 514 set the LED color and the LED intensity of the LEDs 515 as indicated.

If the command received does not indicate a change in LED color and/or LED intensity in step 702, the slave streetlight 106-slave streetlightₙ 108 continue to listen for radio signals in step 701. Note that the changes in LED color and LED intensity depend upon the environmental conditions or an emergency alert. Thus, the master streetlight 105 would transmit data indicative of the LED color and/or LED intensity based upon the environmental conditions or the emergency alert.

If the master streetlight 105 is not operational and communicating with the slave streetlight 106-slave streetlightₙ 108 in step 705, the slave streetlight 106-slave streetlightₙ 108 begin operating autonomously in step 706. In this regard, the slave streetlight 106-slave streetlightₙ 108 may comprise back up data indicative of an LED color and LED intensity to be used when the master streetlight 105 is not operational and is not communicating. In such a scenario, the slave streetlight 106-slave streetlightₙ 108 transmit data indicative of the back up LED color and LED intensity to the LED drivers 514, and the LED drivers 514 set the LEDs 515 to the back up LED color and LED intensity.

1. An automated streetlight system, comprising:
a master streetlight, the master streetlight comprising a network interface, at least one master streetlight light emitting diode (LED), and a plurality of sensors for collecting environmental information;
a slave streetlight, the slave streetlight comprising at least one slave streetlight LED; and
a master streetlight processor configured to determine an LED color and an LED intensity based on the collected information, the master streetlight processor further configured to active the at least one master streetlight LED and the at least one slave streetlight LED based on the environmental information.

2. The automated streetlight system of claim 1, further comprising a streetlight controller server, the streetlight controller server comprising a network interface.

3. The automated streetlight system of claim 2, wherein the master streetlight is communicatively coupled to the streetlight controller server.

4. The automated streetlight system of claim 3, wherein the master streetlight processor is configured to transmit the collected environmental information to the streetlight controller server.

5. The automated streetlight system of claim 4, wherein the streetlight controller server comprise a streetlight controller server processor configured to determine an LED color and an LED intensity based upon the environmental information.

6. The automated streetlight system of claim 5, wherein the streetlight controller server processor is configured to transmit data indicative of the determined LED color and determined LED intensity to the master streetlight.

7. The automated streetlight system of claim 6, wherein the master streetlight is configured to exhibit the determined LED color and the determined LED intensity via the master streetlight LED.

8. The automated streetlight system of claim 7, wherein the master streetlight is configured to transmit data indicative of the determined LED color and the determined LED intensity to the slave streetlight.

9. The automated streetlight system of claim 8, wherein the slave streetlight is configured to exhibit the determined LED color and the determined LED intensity via the streetlight LED.

10. The automated streetlight system of claim 1, further comprising a user interface device.

11. The automated streetlight system of claim 10, wherein the user interface device is configured to receive input from a user and manipulate the master streetlight LED color and LED intensity and the slave streetlight LED color and LED intensity.

12. The automated streetlight system of claim 10, wherein the user interface device enables a user to install a master streetlight and/or a slave streetlight.

13. The automated streetlight system of claim 10, wherein the user interface device is a cellular phone, a tablet, a laptop and/or a personal computer.

14. The automated streetlight system of claim 1, wherein the plurality of sensors comprises a rain module, a barometer, a humidity sensor and/or a temperature sensor.

15. The automated streetlight system of claim 1, wherein the master streetlight processor determines the master streetlight LED color and LED intensity and the slave streetlight LED color and LED intensity based upon information collected by the rain module, the barometer, the humidity sensor and/or the temperature sensor.

16. The automated streetlight system of claim 15, wherein the master streetlight processor transmits data indicative of the determined LED color and the determined LED intensity to the slave streetlight.

17. The automated streetlight system of claim 16, wherein the slave streetlight processor is configured to exhibit the determined LED color and LED intensity received from master streetlight processor.

18. The automated streetlight system of claim 1, further comprising a third-party server, the third-party server comprising a processor configured to transmit data indicative of medical emergency, a nearby fire emergency, construction, or weather warnings, and/or tornados to the master streetlight.

19. The automated streetlight system of claim 1, wherein the master streetlight is configured to determine the master streetlight LED color and master streetlight LED intensity based upon the data received from the third-party server.
